(19) United States
(12) Patent Application Publication
(10) Pub. No.: US 2011/0204714 A1
(43) Pub. Date: Aug. 25, 2011

(54) ELECTRIC POWER SUPPLY SYSTEM, IN PARTICULAR IN AN AIRCRAFT

(75) Inventors: Bernd Speth, Ueberlingen (DE); Ronny Knepple, Ueberlingen (DE)

(73) Assignee: DIEHL AEROSPACE GMBH, Ueberlingen (DE)

(21) Appl. No.: 13/125,172

(22) PCT Filed: Oct. 6, 2009
(86) PCT No.: PCT/EP2009/007150

§ 371 Date: Apr. 20, 2011

(30) Foreign Application Priority Data
Oct. 29, 2008 (DE) 10 2008 053 745.4
Jan. 20, 2009 (DE) 10 2009 005 270.4

(51) Int. Cl. B60L 1/00

(52) U.S. Cl. 307/9.1

(57) ABSTRACT

A fail-safe electrical power supply system (11), in particular in an aircraft, does not require any hardware, control-engineering or wiring complexity for an emergency power supply, which need be started up only when required, if, on the output side, the normal supply has parallel-connected supply modules (13) such as rechargeable batteries or, in particular, fuel cells, which are each loaded as far as possible at the optimum operating point or efficiency, but in any case below their maximum load capacity. If there are a sufficient number of modules (13), on the basis of this power difference, the spare power and energy which are kept available are sufficient to continuously satisfy the power demand of the connected loads, provided that only at least one module (13) remains serviceable. A module (13) which has not failed is then admittedly operated at lower efficiency but still in the permissible low range, ensuring that the operating supply to the loads is maintained without interruption.

The invention relates to an electrical power supply system, in particular in an aircraft.

A system such as this is known from DE 10 2007 017 820 A1. In order to make it possible to dispense with the conventional turbine-generator system, whose hardware is very complex, on board an aircraft and which is used only in the special case of an emergency supply situation, and therefore virtually never, but which must still nevertheless be maintained for continuous operational treadiness, it is envisaged that this system will be replaced there by a fuel cell for the emergency power supply. However, because an uninterruptable power supply must be maintained even in the event of an emergency, an energy store with the same emergency performance is additionally kept available and is continuously recharged from the regular power supply in order to make it possible to boost the starting phase of the fuel cell in the event of failure of the normal power supply.

However, this once again involves functional and hardware complexity, whose continuous serviceability must be ensured, even though it is never intended to be required. There is always uncertainty as to whether the intrinsically unused emergency power system would actually reliably start to operate if necessary. This is because a so-called hidden defect, which does not occur in a system where it is not in operation, conserves the residual risk of an emergency power supply such as this.

Although it is not always necessary to supply all the equipment from the emergency power supply as well, there are, in particular, numerous galley and passenger convenience functions which are available solely from the normal power supply, and which can be used to limit the required emergency power. However, the costs and the installation volume of the emergency power supply unavoidably increase with the major rising demand from the normal power supply, and even more than proportionately because, particularly in passenger aircraft, the traditionally fluid control systems which are essential for operation are currently increasingly being replaced by electrical control systems. The generally increasing electrical power demand can scarcely still be coped with by the engine generators, which are in consequence becoming ever heavier; in the case of the B787 aircraft, each jet engine is having to have two electrical generators integrated in it, thus additionally increasing the complexity and the maintenance effort.

With the knowledge of such circumstances, the invention is based on the technical problem of reliably designing an electrical power supply, in particular for use in an aircraft, such that there is no need for the complexity of an autonomous emergency power supply which additionally has to be kept ready to operate.

According to the invention, this object is achieved by the essential features specified in the main claim. Subsequently, an output-side parallel circuit of a plurality of autonomously serviceable, modular electrical energy sources, such as passive stores or active cells which are all loaded only in the particularly economic mode below their maximum permissible load, are used for the normal power supply. If a module in this power supply system were to fail, those modules which remain serviceable are necessarily loaded more heavily. Although they are then operated less efficiently, no emergency power management is however, required at all for this standby or load-relief function; if at least one of the modules fails, the others need not be started and run up first since, in fact, they are already operating in a controlled mode and are subsequently merely loaded somewhat more heavily, with the previous contribution from the failed module being distributed between all the others. This continuously present, normal operation of tested modules, instead of simple operational readiness of a special redundant supply system, can be referred to as “hot redundancy”.

The modules are therefore always loaded equally in parallel and need not be installed close to one another, but can also be distributed throughout the load areas, for example the cabin of a commercial aircraft. This power supply preferably consists of groups of modules (energy sources) which operate in parallel. If the groups are locally allocated to the substantial energy loads, this leads to a significant reduction in the complexity of supply cables that need to be laid, in terms of space requirements and weight.

One significant feature of this modularized power supply is therefore that each of its modules has a significant energy result during normal operation. The quotient, rounding that to an integer, of the available maximum power of a module and its optimum operating load, which is less than this, is referred to for the purposes of the present invention as the modulation level m of this module system. With conventional active power supply modules, this is typically in the order of magnitude of m=3. This is at the same time the minimum number of modules which can be operated in parallel in the power supply system. The power supply is then ensured until m−1 modules fail, because the single module which then still remains serviceable can still also provide the power for the m−1 failed modules—in which case, it will, of course, correspondingly be loaded more heavily, even up to the maximum, and therefore with the correspondingly poorer efficiency, although it is still not functionally critically overloaded, even during continuous operation. The power requirement for the loads which are connected to the power supply system which is fed from this module group therefore remains covered continuously, even in the extreme emergency system in which all but one of the modules have failed, and there is no need to switch selected loads to an emergency power supply system which is only now being started up.

Depending on the type-typical functional reliability of the respective module and the overall system reliability to be aimed for, the number of modules in the power supply system or a module group will in practice be to a greater or lesser extent above the calculated quotient. Once again in the interest of overall reliability, the groups should not all be designed to be completely identical in terms of the modules which are in each case interconnected in them, in terms of the provision of functional power for the modules, and in terms of the loads which are connected to their power supply system. This is because, in the case of the dissimilar subsystems which are made possible by the modulization, the failure probability (in comparison to mutually identical systems) is considerably reduced, as a result of which it is less probable that the same module failures will occur at the same time in two different module groups.

In particular, the passive modules may be rechargeable batteries which, for example, are recharged during operation by means of at least one generator, which is still physically small and is driven, for example, by a ram-air turbine. Alternatively, these rechargeable batteries could he recharged (rapid charging) or replaced on the ground. The modulation level of the rechargeable batteries is governed by their maximum permissible load in comparison to the optimum load; the latter of these represents a compromise between high (discharge) efficiency with a high output voltage because the discharge current value is low, and low (discharge) efficiency with a low output voltage because of small dimensions (a small number of cells or cell size).

However, active modules such as batteries, and in particular in the form of fuel cell systems, are preferably used, which are operated using regeneratively available fuels such as hydrogen, methanol or ethanol. The physical-technical relationship between optimum power and maximum power of a fuel cell actually allows a high-availability power supply to be achieved by means of the modularization according to the invention, resulting in even greater redundancy, in the case of the additional dissimilarity of the module designs because of the improbability of serious faults occurring at the same time, and in any case avoiding the complexity for an autonomous emergency power supply.

The exemplary embodiments sketched in the drawing relate to fuel cell modules, further features and advantages of which will become evident from the following explanation thereof, in addition to the developments and alternatives of the present invention that are characterized in the dependent claims. In the drawing:

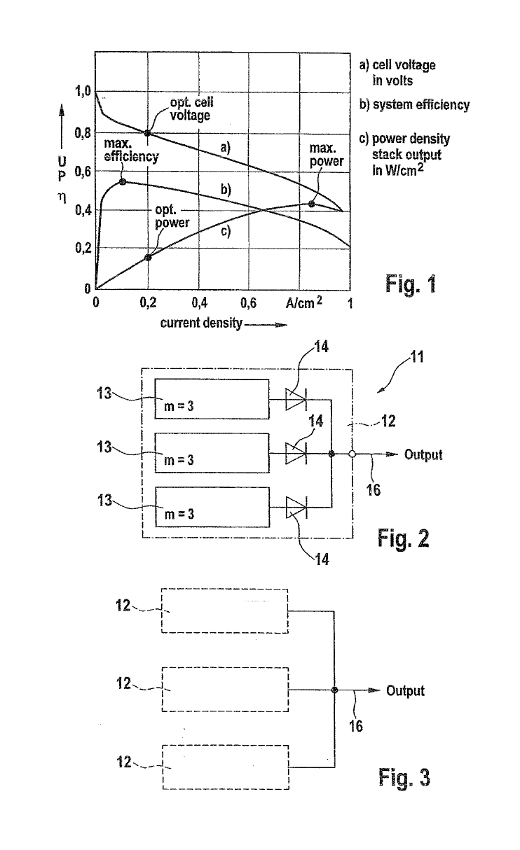

FIG. 1 shows the influencing variables on the modulation level of a fuel cell as a supply module,

FIG. 2 shows a group of three modules,

FIG. 3 shows grouped groups as shown in FIG. 2,

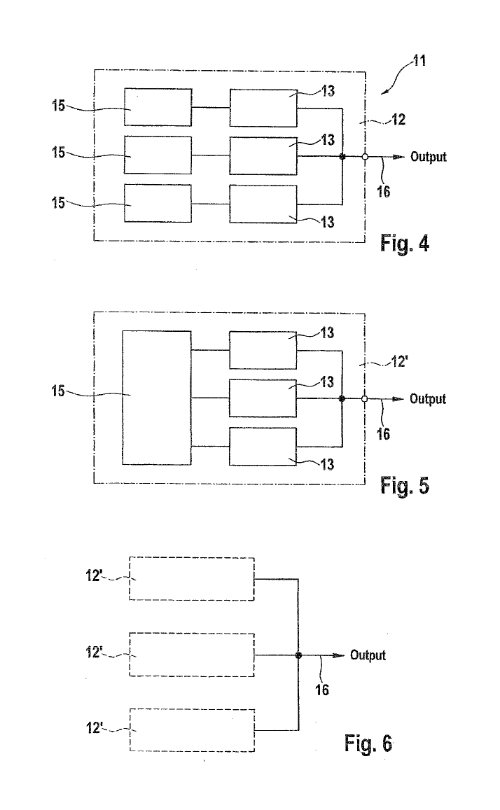

FIG. 4 shows a group with a modular peripheral for the function of the modules,

FIG. 5, in comparison to FIG. 4, shows a simplified form of the architecture by reference back to a robust central peripheral, and

FIG. 6 shows a superordinate system comprising a plurality of groups as shown in FIG. 5.

When operating a stack of fuel cells, an operating point should be aimed for which on the one hand results in the fuel consumption being low (low load and/or high cell voltage) and on the other hand requires only a small stack size (the so-called stack composed of cells which are individually electrically connected in series). The cell voltage falls as the load current rises. Therefore, for a specific current and for the type-typical optimum cell voltage of around 0.8 volts, operation is carried out on the one hand with an efficiency which is still relatively very low and on the other hand with a stack size that is still acceptable, as is shown in FIG. 1. The maximum load on a fuel cell with a family of characteristics as shown in FIG. 1 is 0.44 watts/cm², but its optimum operating power is 0.15 watts/cm². This difference results in a modulation level of m=3, for the power density quotient thereof for this cell.

Therefore, cf. FIG. 2, (at least) three such cells are connected in parallel as modules 13 for the modular power supply for a load network 16. If one or even two of these modules 13 fail, the module 13 which still remains is correspondingly more heavily loaded, as a result of which the relative consumption of fuel will rise, and the efficiency will thus fall—but the power supply to the loads which are connected to the output of such a group 12 remains free of interruptions, and is maintained without functionally critical overloading of the remaining cell. The power demanded by the loads is therefore continuously still available by means of the power supply system with this module group 12, which need not first of all be switched on but is in any case being operated in a monitored form. Depending on the safety requirements, the modulation level of the hardware design can also be increased, but it should be at least m=3.

The power supply system 11, which is sketched in the form of a single-pole block diagram in FIG. 2, consists of a group 12 of three fuel cell stacks as the modules 13 which supply the DC voltage to the network 16 of loads (not sketched), each of modulation level 3. On the output side, the modules 13 are connected in parallel via decoupling circuits 14 which are indicated functionally here, by diodes. These are used to protect the modules 13 against reverse voltages which would damage their operation. In practice, high-power semiconductor switches with low power losses are used here. In contrast, when using fuel cells which are resistant to reverse voltages, as in the case of so-called reversible fuel cells, there is also no need for such precautionary measures, cf. FIG. 4.

FIG. 3 indicates that the groups 12 can themselves be grouped to form a superordinate system, correspondingly improving the operational reliability of an overall system such as this. This is because, with the illustrated architecture, the failure of one of its modules of modulation level m=3 reduces the (unregulated) system power by only 1/9 and, with a constant (regulated) system power, increases the power of the other 8 modules by only 9/8=12.5%. Simple functional reliability is therefore sufficient for the individual components in the groups 12, and there is no need to provide any special reliability complexity for their components. As can be seen from FIG. 4, each of the modules 13 is expediently supplied via its own installation or functional peripheral 15. in the case of rechargeable batteries, these are, for example, recharging generators while, in the case of fuel cells, these represent the provision (replenishment, storage and supply) of their operating gases (fuels and oxidants for the cell function), as well as the auxiliary devices that are required for their operation, such as moisturization and demoisturization, and for cooling.

When a particularly functionally robust peripheral 15 is present, for example as is the case of a recharging generator which requires no special auxiliary operating devices, for rechargeable batteries, the geometry for at least some of the groups 12′ is simplified by the use of a common peripheral 15 as shown in FIG. 5.

As is shown in FIG. 6, groups 12′ designed in this way make it possible to produce a more compact, superordinate system.

Therefore, according to the invention, a fail-safe electrical power supply system 11, in particular in an aircraft, does not require any hardware, control-engineering and wiring complexity at all for an autonomous emergency power supply, which need be started up only when required, if supply modules 13 which are functionally of the same type and are connected in parallel on the output side, such as rechargeable batteries or, in particular, fuel cells, are provided for the normal supply of the load network 16 with each module 13 being loaded as far as possible at the optimum operating point or efficiency, but in any case considerably below the maximum load capacity. With this energy reserve, a correspondingly large number of modules 13 can continuously satisfy the power demand of the loads which are connected to the network 16, provided that only at least one of the modules 13 remains serviceable after any failure of modules 13. A module 13 which has not failed will admittedly continue to operate at lower efficiency, but still within the permissible load range, after the failure of one of the other modules 13 which feeds this network system 16, and the operating supply to the loads is therefore maintained, without interruption.

### LIST OF REFERENCE SYMBOLS

11 Power supply system (for 16)
12 Group (of 13)
13 Modules (to 16)
14 Decoupling circuits (between 13 and 16)
15 Functional peripheral (for 13)
16 Load network

1. An electrical power supply system, in particular for a load network in an aircraft, characterized in that a plurality of power supply modules which are operated in parallel below their maximum load capacity are connected to the network.

2. The power supply system as claimed in claim 1, wherein the modules are designed for loading at the optimum operating point or efficiency.

3. The power supply system as claimed in claim 1, wherein the number of interconnected modules is at least as great as the quotient of the powers of the maximum and optimum load of the modules.

4. The power supply system as claimed in claim 1, wherein the modules are connected to the power supply system, distributed over the network.

5. The power supply system as claimed in claim 1, wherein the number of modules which exceeds the power quotients are in each case connected to the network, combined to form groups.

6. The power supply system as claimed in claim 5, wherein the groups are connected to the power supply system, distributed over the network.

7. The power supply system as claimed in claim 5, wherein groups combined to form superordinate systems are connected to the network.

8. The power supply system as claimed in claim 1, wherein modules with the same power quotients are designed with different hardware.

9. The power supply system as claimed in claim 1, wherein each module is connected to its own peripheral.

10. The power supply system as claimed in claim 1, wherein modules which are combined in groups are connected to a common peripheral.

11. The power supply system as claimed in claim 1, wherein rechargeable batteries, which are recharged from a generator or on the ground or are replaced, are provided as passive modules.

12. The power supply system as claimed in claim 1, wherein fuel cells are provided as active modules.

13. The power supply system as claimed in claim 1, wherein decoupling circuits are provided between the modules and the network.
